(19) United States
(12) Patent Application Publication
(10) Pub. No.: US 2011/0035388 A1
(43) Pub. Date: Feb. 10, 2011

(54) METHOD AND APPARATUS FOR RECOMMENDING INFORMATION USING A HYBRID ALGORITHM

(75) Inventors: Sung-Bin IM, Yongin-si (KR); Se-Rin Hong, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si, (KR)

(21) Appl. No.: 12/670,248

(22) PCT Filed: Apr. 14, 2008
(86) PCT No.: PCT/KR08/02080

§ 371 Date: Sep. 13, 2010

(30) Foreign Application Priority Data
Jan. 2, 2008 (KR) 10-2008-0000157

(51) Int. Cl. G06F 17/30

(52) U.S. Cl. 707/754; 707/E17.059

(57) ABSTRACT

A method and apparatus for recommending information is provided. When a client accesses a server and requests information, the server determines whether the client is included in a meaningful set (MS) and generates first preference information of the client based on an access history of the client, or based on additional information directly input by the client. Then, the server selects a number of neighborhood groups including clients having preferences similar to a preference of the client, and generates and transmits first item information on a number of items preferred by the clients of the neighborhood group to the client. The client extracts second item information to be recommended to a user by filtering the first item information with second preference information. Information is filtered respectively by the server and the client by using different algorithms. Accordingly, it is possible to improve the accuracy and speed of recommending information.

### CROSS REFERENCE TO RELATED APPLICATIONS

This application is a National Stage of International Application No. PCT/KR2008/002080, filed Apr. 14, 2008, claiming priority to Korean Patent Application No. 10-2008-0000157, filed Jan. 2, 2008, and U.S. Provisional Application No. 60/951,509, filed Jul. 24, 2007, the contents of all applications being incorporated herein by reference in their entirety.

### TECHNICAL FIELD

Apparatuses and methods consistent with embodiments relate generally to recommending information, and more particularly, to recommending information by using a hybrid algorithm capable of accurately and speedily recommending information that reflects a category preference of a user.

### BACKGROUND

As it is possible to search for a tremendous amount of information due to development of Internet search techniques, a method of speedily extracting information suitable for a user from the tremendous amount of searchable information on the Internet is needed. An attribute-aware (AA) algorithm and a collaborative filtering (CF) algorithm are used to search for information as a typical algorithm of methods of filtering information suitable for the user. Where a user searches for items such as books, music, movies, and the like on the Internet, the aforementioned algorithm is used so as to provide a search result suitable for the user.

The AA algorithm provides a method of filtering item information by analyzing an attribute of the user and attributes of items. Search results of users having attributes similar to the attribute of the user are also analyzed. Items selected by many users with similar attributes or highly evaluated items are searched for. Information on the items is provided to the user.

The CF algorithm provides a widely used method of analyzing a preference of a user based on a past search result of items of the user and searching for an item selected by users of a group having a preference similar to the preference of the user. An item selected by many users belonging to the group or item to which a high evaluation score is allocated is selected, and information on the item is provided to the user.

Since the CF algorithm uses the past search result of items of the user, a “first user problem” exists because it is difficult to accurately recommend information for an initial user having no data for the past search result of items by using this method. In addition, a sparsity problem exists where the number of items is much greater than the number of users, as data for distinguishing groups with similar preferences is deficient, and filtering accuracy is decreased.

Accordingly, although a hybrid algorithm obtained by combining the two AA and CF algorithms has been suggested, most methods of filtering information by using the hybrid algorithm have a disadvantage in that a filtering speed is very slow, and it is difficult to implement the hybrid method. If attribute data for applying the AA algorithm is combined with historical user preference data for applying the CF algorithm, the amount of data is too large, and the filtering speed is decreased. Accordingly, a method and apparatus for recommending information is still desired.

### SUMMARY

One or more exemplary embodiments provide a method and apparatus for recommending information by using a hybrid algorithm capable of filtering information by considering a personal preference of a user while not deteriorating a speed of filtering information.

According to one exemplary embodiment, there is provided a method of recommending information by a server, the method comprising receiving a request from a client for recommending information on at least one item among items of the server; generating first preference information by analyzing an item preference of the client; selecting a neighborhood group including clients having preferences similar to a preference of the client based on the first preference information; and transmitting first item information to the client on at least one item preferred by the clients of the neighborhood group among the items of the server, wherein the client receives the first item information and extracts second item information to be recommended for a user by filtering the first item information again based on second preference information which represents an item preference of the client.

According to one exemplary embodiment, there is provided a server device for recommending information, the server device comprising a request receiving unit receiving a request for recommending information on at least one item among items of the server from a client; a preference generation unit generating first preference information by analyzing an item preference of the client; a group selection unit selecting a neighborhood group including clients having preferences similar to a preference of the client based on the first preference information; and an information generation unit transmitting first item information on at least one item preferred by the clients of the neighborhood group among the items of the server to the client, wherein the client receives the first item information and extracts second item information to be recommended for a user by filtering the first item information again based on second preference information which represents an item preference of the client.

In another exemplary embodiment, a client device for receiving a recommendation of information is provided, the client device comprising a request transmission unit requesting a server to recommend information on at least one item among items of the server; an information receiving unit receiving first item information on items preferred by clients of a neighborhood group selected based on first preference information which represents an item preference of the client from the server; a preference generation unit generating second preference information which represents an item preference of the client; and an information generation unit generating second item information on items to be recommended for a user by filtering the received first item information based on the second preference information, wherein the neighborhood group is a group of clients having preferences similar to a preference corresponding to the first preference information.

In a further exemplary embodiment, there is provided a method of recommending information, the method comprising generating first recommendation information by allowing a server to filter information by using a first information filtering algorithm; and generating second recommendation information by allowing a client to filter the first recommendation information by using a second information filtering algorithm.

In another exemplary embodiment, a computer system is provided with a computer-readable recording medium having embodied thereon a computer program for executing the method of recommending information on the computer system.

Accordingly, since a server and a client performs a filtering process by using different algorithms for filtering information, the speed of filtering information is increased. Since the filtering process is performed by considering a personal preference of a user in two filtering processes, it is possible to recommend accurate information for the user.

### BRIEF DESCRIPTION OF THE DRAWINGS

The above and other features and advantages will become more apparent by describing in detail exemplary embodiments thereof with reference to the attached drawings in which:

FIG. 1 is a flowchart of a method of recommending information by using a server, according to an exemplary embodiment;

FIG. 2 is a flowchart of a method of generating first preference information, according to an exemplary embodiment;

FIG. 3 is a flowchart of a method of recommending information by using a client according to an exemplary embodiment;

FIG. 4 illustrates a table with item preference scores, category preference scores, and weighted scores for a plurality of items, according to an exemplary embodiment; and

FIGS. 5A and 5B illustrate a server and a client for recommending information, according to an exemplary embodiment.

### DETAILED DESCRIPTION OF EXEMPLARY EMBODIMENTS

According to an exemplary embodiment, there is provided a method of recommending information by a server, the method including receiving a request from a client for recommending information on at least one item among items of the server; generating first preference information by analyzing an item preference of the client; selecting a neighborhood group including clients having preferences similar to a preference of the client based on the first preference information; and transmitting first item information to the client on at least one item preferred by the clients of the neighborhood group among the items of the server, wherein the client receives the first item information and extracts second item information to be recommended for a user by filtering the first item information again based on second preference information which represents an item preference of the client.

According to another exemplary embodiment, there is provided a method of receiving a recommendation of information by a client, the method including requesting a server to recommend information on at least one item among items of the server; receiving first item information from the server on items preferred by clients of a neighborhood group selected based on first preference information, the first item information representing an item preference of the client; and generating second item information on items to be recommended for a user by filtering the received first item information based on second preference information which represents an item preference of the client, wherein the neighborhood group is a group of clients having preferences similar to a preference of the user corresponding to the first preference information.

The second preference information may be information on a preference of categories of items included in the first item information that is generated based on a result of the client's history of accessing the items of the server.

According to another aspect, there is provided a server device for recommending information, the server device including a request receiving unit receiving a request from a client for recommending information on at least one item among items of the server; a preference generation unit generating first preference information by analyzing an item preference of the client; a group selection unit selecting a neighborhood group including clients having preferences similar to a preference of the client based on the first preference information; and an information generation unit transmitting first item information to the client on at least one item preferred by the clients of the neighborhood group from among the items of the server, wherein the client receives the first item information and extracts second item information to be recommended to a user by filtering the first item information again based on second preference information which represents an item preference of the client.

According to another aspect, there is provided a client device for receiving a recommendation of information, the client device including a request transmission unit requesting a server to recommend information on at least one item among items of the server; an information receiving unit receiving first item information on items preferred by clients of a neighborhood group, the neighborhood group selected based on first preference information which represents an item preference of the client from the server; a preference generation unit generating second preference information which represents an item preference of the client; and an information generation unit generating second item information on items to be recommended for a user by filtering the received first item information based on the second preference information, wherein the neighborhood group is a group of clients having preferences similar to a preference corresponding to the first preference information.

According to another aspect, there is provided a method of recommending information, the method including generating first recommendation information by allowing a server to filter information by using a first information filtering algorithm; and generating second recommendation information by allowing a client to filter the first recommendation information by using a second information filtering algorithm.

In one exemplary embodiment, the information filtering algorithm may be a collaborative filtering (CC) algorithm, and the second information filtering algorithm may be an attribute-aware (AA) algorithm.

According to another exemplary embodiment, there is provided a computer system with a computer readable recording medium having recorded thereon a program for executing the method of filtering the information on the computer system.

Hereinafter, reference will now be made in detail to the exemplary embodiments with reference to the attached drawings.

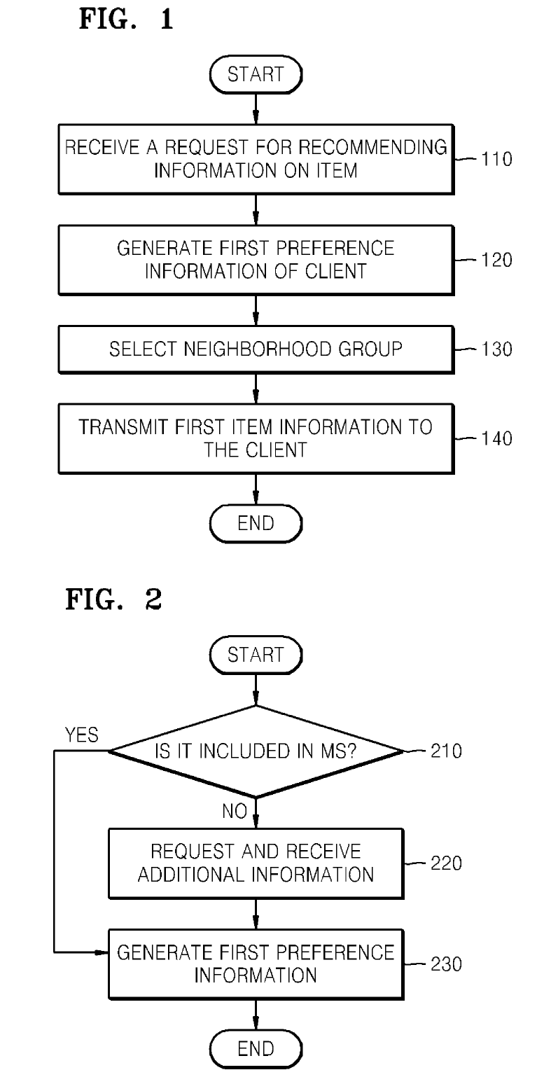

FIG. 1 is a flowchart of a method of recommending information by using a server, according to an exemplary embodiment. As described above with reference to a related technique, a disadvantage of a hybrid algorithm obtained by combining an attribute-aware (AA) algorithm with a collaborative filtering (CF) algorithm is a low speed of filtering information. Accordingly, in the method of recommending information according to the exemplary embodiment, the server first filters information to be recommended for a user by using a first information filtering algorithm, for example, the CF algorithm. A client secondly filters the server-recommended information obtained from the server-filtered result by using a second information filtering algorithm, for example, the AA algorithm, so as to generate a final set of recommended information.

FIG. 1 is a flowchart of the first filtering method that is performed by the server between two filtering processes. In the method of recommending information shown in FIG. 1, information is filtered based on the CF algorithm. However, information is filtered by using a meaningful set (MS) so as to solve a first-user problem that the user who initially accesses information cannot use the CF algorithm, and to solve a sparsity problem that filtering accuracy deteriorates due to deficiency of data for distinguishing groups with similar preferences from one another where the number of items is considerably greater than that of the number of users.

In operation 110, the server is requested to recommend information on at least one item among a plurality of items of the server. The server receives a message for requesting a recommendation of a specific type of item from a client or receives a message from a client requesting any type of item. The client requests the server to recommend information on at least one item among items included in the server by logging into the server with an ID allocated to a user of the client.

Here, items of the server may be directly included in the server or included in another server capable of providing items searched for on the server by the client. The items of the server may be, for example, content items such as books, music, movies, and documents. Here, the documents may be, for example, electronic documents or web documents.

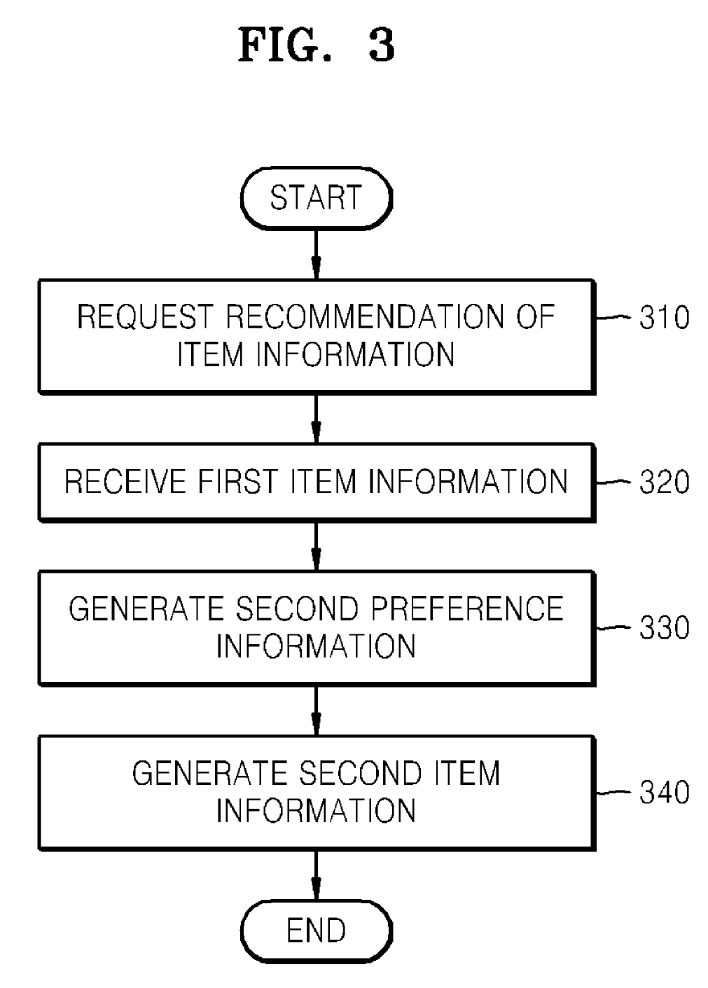

In operation 120, the server generates first preference information by analyzing an item preference of the client. The item preference of the client is analyzed based on a client's past access result or additional information generated and transmitted by the client. As a result of the analysis, the first preference information is generated. This generation of the first preference information is described in detail with reference to FIG. 2.

FIG. 2 is a flowchart of a method of generating first preference information, according to an exemplary embodiment.

Referring to FIG. 2, in operation 210, the server determines whether a client which requests a recommendation of information is included in a meaningful set. As described above, the method of recommending information according to the exemplary embodiment uses the meaningful set (MS) so as to solve the first-user problem and the sparsity problem. The MS indicates a set of clients having the number of accesses to the items of the server which is equal to or greater than a predetermined number. The past access result of the client having the number of accesses to the items of the server which is less than the predetermined number is not used to filter information. Specifically, when a client which requests a recommendation of information in operation 110 has a number of accesses to the items of the server which is less than the predetermined number, the past access result of the client is not used to filter information. Accordingly, the server generates the first preference information using different methods by determining whether the client which requests a recommendation of information in operation 210 is included in the MS.

In operation 220, when it is determined that a client is not included in the MS in operation 210, that is, when the number of accesses to the items of the server is less than a predetermined number, the server requests the client to transmit additional information needed for generating the first preference information of the client, and receives the additional information as a response to the request.

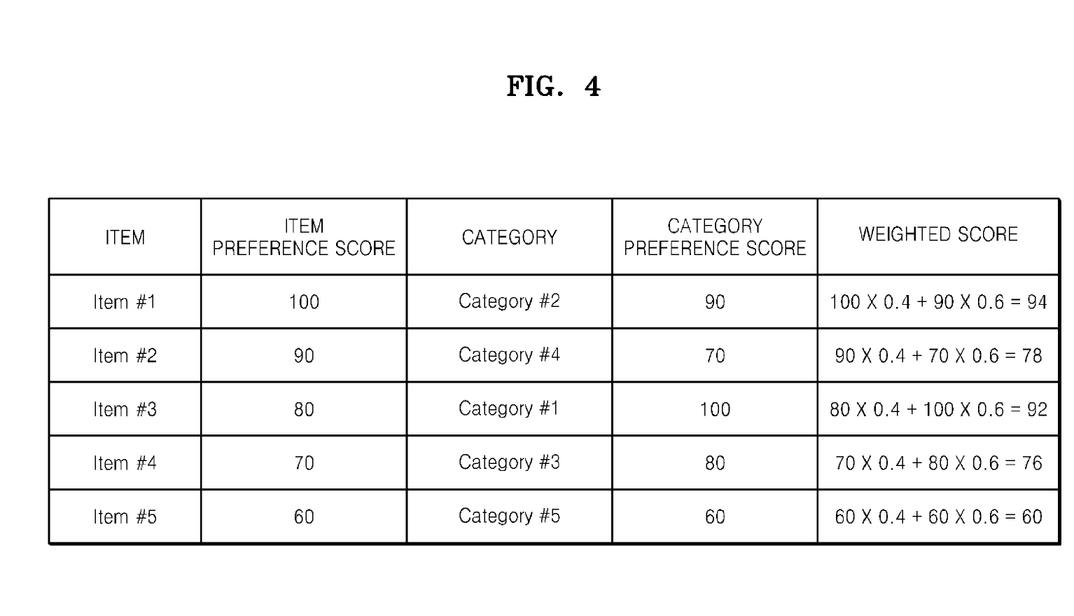

The additional information may include information on an attribute of a user of the client and information on an attribute of a preferred item. The attribute of the user may include information on an age, an occupation, and the like. The attribute of the item may include information on a general attribute on types of items such as books, movies, music and the like. These attributes are different from attributes of items that are the basis for generating second preference information to be used for the method of recommending information by using the client. These attributes will be described in detail with reference to FIG. 3. The additional information may include information on a preference that is directly input by the user and information on a history of searches and purchases of items of the server by the client up to a current time. The additional information may be temporary fake data for analyzing the first preference information of the client having the number of accesses to the items of the server which is less than the predetermined number.

In operation 230, the server generates the first preference information of the client. When the client having the number of past accesses to the items of the server which is equal to or greater than the predetermined number is included in the MS, the first preference information is generated based on the client's past results of accessing the items of the server. Types of items, the number of accesses to the items with the types, and the like are generated as the first preference information.

Where the client having the number of accesses to the items is not included in the MS, the first preference information is generated based on the additional information received from the client in operation 220.

Returning to FIG. 1, when the first preference information is generated in operation 120, the server selects a neighborhood group which includes other clients having preferences similar to a preference corresponding to the generated first preference information in operation 130. A group of clients having preferences similar to the preference corresponding to the first preference information of the client is selected by comparing the first preference information with preference information of other clients which access the items of the server. In an exemplary embodiment, a group including M number of clients having preferences similar to the preference of the client is selected. In operation 140, the server generates first item information on at least one item preferred by the clients of the neighborhood group generated in operation 130, and transmits the first item information to the client which requests recommendation of information in operation 110.

The server generates preference scores of the items of the server by analyzing information on the number of accesses of the server by the clients of the neighborhood group and information on scores provided by the clients of the neighborhood group when accessing and evaluating the items of the server. The preference score is a value obtained by converting the preference of the item by clients of the neighborhood group into a number. Where the number of accesses of the clients of the neighborhood group is large, or where scores provided when clients evaluating the items are high, the preference score is high. Otherwise, the preference score is low.

When the preference scores on the items of the server are calculated, the server gathers information on N number of items having high preferences so as to generate first item information. The generated first item information is transmitted to the client which requests recommendation of information in operation 110. In the method of recommending information according to the exemplary embodiment, the information recommended by the server is not used as is, but is instead filtered again by reflecting a personal preference of the user, as described further below. Accordingly, the first item information generated in operation 140 is only firstly recommended information.

FIG. 3 is a flowchart of a method of recommending information through the use of a client, according to an exemplary embodiment.

FIG. 3 is a flowchart of a secondary filtering method performed by the client between two filtering processes performed in the method of recommending information according to the embodiment. In the method of recommending information at the client shown in FIG. 3, information is filtered based on the AA algorithm. When the server generates the first item information corresponding to the preference of the neighborhood group by filtering information by using the CF algorithm, the client further filters the first item information by using the AA algorithm and generates second item information which reflects a personal preference of the user of the client. First, the information is filtered through the CF algorithm so as to generate the first item information. Since the generated first item information is additionally filtered through the AA algorithm, the amount of data used for both filtering steps is increased to the point that the sparsity problem encountered with the conventional technique is solved. Since information is filtered by the server using the CF algorithm and the client using the AA algorithm, it is possible to minimize a load on the server. Accordingly, it is possible to improve a speed of filtering information.

In operation 310, the client requests the server to recommend information on at least one item among items of the server. Operation 310 corresponds to operation 110 shown in FIG. 1. The client logs in to the server with an ID allocated to the user of the client and requests the server to recommend information on the at least one item among the items of the server.

In operation 320, the client receives the first item information from the server. The client receives the first item information that is information on N number of items which is generated by performing the first filtering of information at the server by using the aforementioned method of recommending information shown in FIG. 1. The first item information includes preference scores on the items. If it is determined that the client is not included in the MS, the first item information received from the server may be information to be finally recommended for the client as it is.

In operation 330, the client generates second preference information. If it is determined that the client is included in the MS, the second preference information is generated based on past results of accessing the items of the server through the client. The second preference information reflects the preference of the user more accurately than the first preference information. Information on preference of a category, including items included in the first item information, is generated as the second preference information.

The first preference information is used to select a neighborhood group. The first preference information is information generated based on upper level attributes such as types of items. On the other hand, the client generates the second preference information by filtering information to reflect a personal preference of a user. The personal preference of the user is an attribute that is more concrete than the standard attribute for generating the first preference information. For example, if the server generates the first preference information that is information on a preference for each item with reference to an upper level attribute such as a type of contents, that is, a book, a movie, and music; the client generates the second preference information that is information on a preference for each category by using a lower level attribute such as a genre, a author, a director, and a composer.

That is, the server generates the first preference information with reference to a general attribute for setting a neighborhood group, not by considering concrete attribute information such as genre or director. The client generates the second preference information with reference to a more concrete attribute such as a genre or director so as to generate the second item information by further filtering the first item information and considering a preference for each genre or each director.

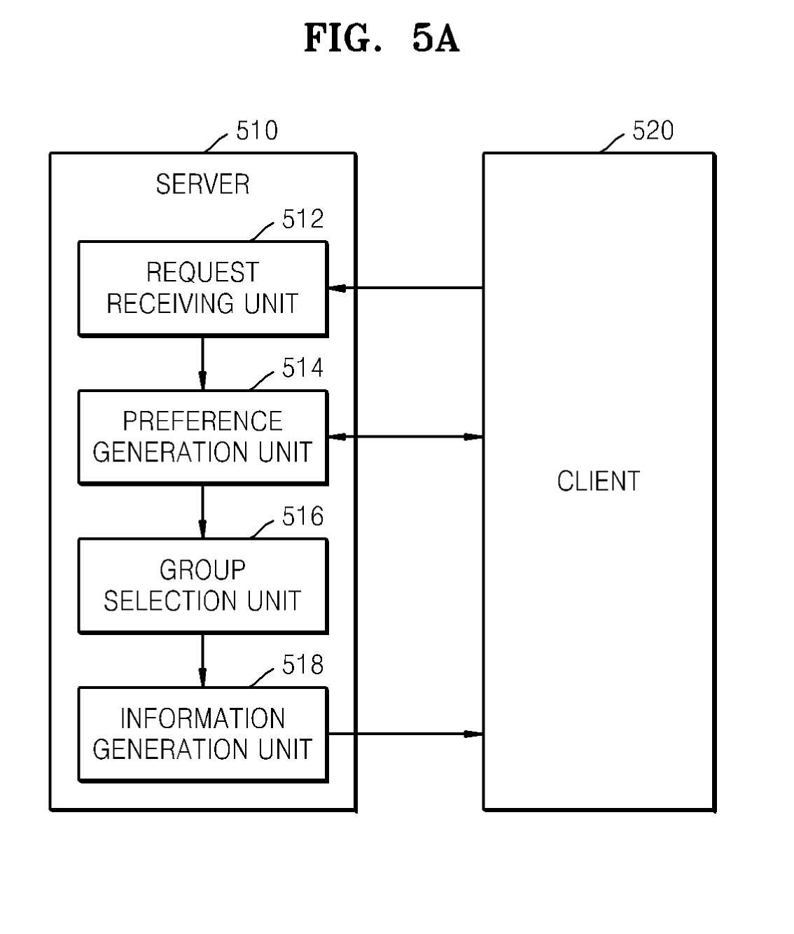

In operation 340, the client generates second item information based on the second preference information generated in operation 330. Operation 340 will be described further with reference to FIG. 4.

FIG. 4 illustrates a table with item preference scores, category preference scores, and weighted scores for a plurality of items, according to an exemplary embodiment.

Referring to FIG. 4, the first item information according to the embodiment includes an Item Preference Score for each item, calculated based on the preference of the neighborhood group, as shown in the second column of the table in FIG. 4. On the other hand, the second item information includes a Category Preference Score of a category, as shown in the fourth column of the table, including items that are included in the first item information.

Although the Item Preference Score of Item #1 of the neighborhood group is 100, the Category Preference Score of Category #2, which includes Item #1, is 90. On the other hand, although an Item Preference Score of Item #3 of the neighborhood group is 80, the Category Preference Score of Category #1 is 100.

The client calculates a final Weighted Score, shown in the fifth column in FIG. 4, by applying weights to the Item Preference Score and Category Preference Score of each Item and Category, respectively. If a weight of Item Preference Scores of Item #1-Item #5 included in the first item information is 0.4, and if a weight of Category Preference Scores of Category #1-Category #5 is 0.6, a weighted score of Item #1 is 94, and a weighted score of Item #3 is 92.

The second item information provided to the user is selected with reference to the Weighted Score obtained by applying weighted values to an Item Preference Score and a Category Preference Score. Some items having high weighted scores may be selected from among Item #1 to Item #5, as shown in FIG. 4. Information on the items is provided to the user.

The client provides the second item information to the user. The user selects one item from the second item information. The client accesses the selected item. The access result is stored in the client so as to be used for the next recommendation of information. The number of accesses to the selected item is increased by one. When the user inputs an evaluation score, the evaluation score is stored. Next, the client may transmit the access result to the server so that the server can update the first preference information for the next recommendation of information based on the access result. In a case where the number of accesses to the items is equal to or less than a predetermined number, only the client stores the access result. It is possible to reduce materials used to filter information in the server by transmitting the access result to the server only when the number of accesses is equal to or greater than the predetermined number.

In the methods of recommending information shown in FIGS. 1 to 4, there are three parameters. The three parameters include the number M of clients included in the neighborhood group, the number N of items firstly recommended by the server, and a number lambda is used to calculate a weight for generating the second item information. According to an exemplary embodiment, it is possible to speedily and accurately recommend information by controlling three parameters.

According to experimental results, if the value of lambda approaches 1, a result of recommending information performed in the server side is recommended to the user without any change in speed. This is not preferable.

In addition, since an increase of the number N of items firstly recommended by the server hardly influences recommendation accuracy, it is not necessary that the number N not be too large.

When the number M of clients included in the neighborhood group is too large, a speed of recommending information is decreased. Accordingly, it is necessary that the number M not be too large. The optimal number M is determined based on a type of recommended items, the number of items of the server, and the like.

In the method of recommending information according to the exemplary embodiment, it was experimentally determined that the three parameters do not largely influence the speed of recommending information, but do influence accuracy of recommending information. The three parameters may therefore be controlled so as to improve the accuracy of recommending information.

Information is recommended many times by slightly adjusting the three parameters. Whenever information is recommended, a speed and accuracy of recommending information are measured so as to search for an optimal combination of values of the three parameters.

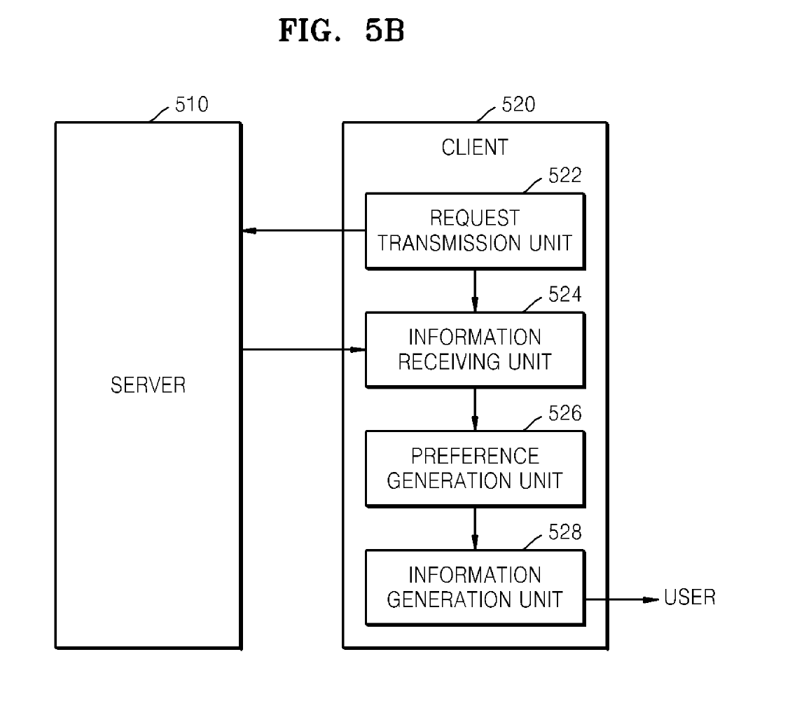

FIG. 5A illustrates a server for recommending information, according to an exemplary embodiment. FIG. 5B illustrates a client for recommending information, according to an exemplary embodiment.

Referring to FIG. 5A, a server device 510 according to the exemplary embodiment includes a request receiving unit 512, a preference generation unit 514, a group selection unit 516, and an information generation unit 518.

In one exemplary embodiment, the receiving unit 512 is requested by a client 520 to recommend information on at least one item among items of the server 510. As described above, the items may be directly included in the server 510 or included in another server (not shown) capable of providing items which are searched for by the server 510 to the client 520.

The preference generation unit 514 generates first preference information by analyzing an item preference of the client. The preference generation unit 514 determines whether the client is included in an MS in which the number of accesses is equal to or greater than a predetermined number. When it is determined that the client is included in the MS, the first preference information is generated based on the past access result of the client.

When it is determined that the client is not included in the MS, the preference generation unit 514 requests the client 520 to provide additional information for generating the first preference information, and receives the additional information that is a response to the request. The first preference information is generated based on the received additional information. The additional information includes information on an attribute of the user of the client, and/or information on an attribute of a preferred item. As described above, the user attribute may include information on an age, an occupation, and the like. The attribute of the item may include information on a general attribute on types of items such as books, movies, music and the like. The additional information may include information on a preference that is directly input by the user, and/or information on a history of searches and purchases of items by the user of the server in the past as fake data.

The group selection unit 516 selects the neighborhood group based on the first preference information generated by the preference generation unit 514. A group of M numbers of clients having preferences similar to the preference corresponding to the first preference information is selected.

The information generation unit 516 generates and transmits information on at least one item preferred by clients of the neighborhood group, that is, the first item information to the client. The preference scores of items preferred by the clients of the neighborhood group are calculated. Information on N number of items having high preference scores is generated and transmitted to the client.

Referring to FIG. 5B, the client device 520 according to the exemplary embodiment includes a request transmission unit 522, an information receiving unit 524, a preference generation unit 526, and an information generation unit 528.

The request transmission unit 522 requests the server 510 to recommend information on at least one item among the items of the server 510.

The information receiving unit 524 receives first item information generated by allowing the server 510 to perform a first information filtering process. The first item information is generated by allowing the server 510 to select a neighborhood group including M number of clients based on first preference information which represents an item preference of the client 520, and to extract information on N number of items preferred by the clients included in the neighborhood group, as described above with regard to FIG. 5A.

The preference generation unit 526 generates second preference information which represents an item preference of the client 520. The second preference information relates to categories of items which are generated by allowing the client 520 to access the items of the server 510 accessed in the past. The second preference information is generated based on a more concrete attribute that is different from the first preference information used to allow the server 510 to select the neighborhood group.

The information generation unit 528 filters the first item information by using the second preference information generated by the preference generation unit 526. Weighted scores are calculated by applying weights to the preference scores and calculating preference scores of items included in the first item information and preference scores of item categories calculated based on the second preference information. Second item information to be recommended for the user is generated based on the generated weighted scores.

While the exemplary embodiments have been particularly shown and described with reference to the drawings thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the exemplary embodiments. The methods and apparatuses according to an embodiment of the invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

What is claimed is:

1. A method of recommending information, the method comprising:
receiving a request from a client for recommending information on at least one item among items of the server;
generating first preference information by analyzing an item preference of the client;
selecting a neighborhood group including clients having preferences similar to a preference of the client; and
transmitting first item information to the client on at least one item preferred by the clients of the neighborhood group,
wherein the client receives the first item information and extracts second item information to be recommended to a user by filtering the first item information with second preference information which represents an item preference of the client.

2. The method of claim 1, wherein the first item information includes preference scores of items, the preference scores generated based on at least one of the number of accesses to the items of the server by the clients of the neighborhood group and evaluation scores allocated to the items of the server.

3. The method of claim 2, wherein the generating of the first preference information includes:
determining whether the number of past accesses to the items of the server by the client is equal to or greater than a predetermined number;
requesting the client to provide additional information for generating the first preference information when it is determined that the number of the past accesses is less than the predetermined number;
receiving the additional information transmitted from the client in response to the request; and
generating the first preference information based on the received additional information.

4. The method of claim 2, wherein the generating of the first preference information includes:
determining whether the number of past accesses to the items of the server by the client is equal to or greater than a predetermined number; and
generating the first preference information based on the number of accesses to the items of the server or the evaluation scores allocated to the items of the server when it is determined that the number of the past accesses is equal to or greater than the predetermined number.

5. The method of claim 1, wherein the items relate to at least one of books, music, movies, and documents.

6. A method of receiving a recommendation of information, the method comprising:
requesting a server to recommend information on at least one item among items of the server;
receiving first item information at a client on items preferred by clients of a neighborhood group, the neighborhood group selected based on first preference information which represents an item preference of the client from the server; and
generating second item information on items to be recommended to a user by filtering the received first item information based on second preference information which represents an item preference of the client,
wherein the neighborhood group is a group of clients having preferences similar to a preference corresponding to the first preference information.

7. The method of claim 6, wherein the second preference information is information on a preference of categories of items included in the first item information, is the second preference information being generated based on a client's past result of accessing the items of the server.

8. The method of claim 7, wherein the generating of the second item information includes calculating weighted values of preference scores of items included in the first item information and weighted values of preference scores corresponding to preferences of categories.

9. A server device for recommending information, the server device comprising:
a request receiving unit receiving a request from a client for recommending information on at least one item among items of the server;
a preference generation unit generating first preference information by analyzing an item preference of the client;
a group selection unit selecting a neighborhood group including clients having preferences similar to a preference of the client; and
an information generation unit transmitting first item information on at least one item preferred by the clients of the neighborhood group to the client,
wherein the client receives the first item information and extracts second item information to be recommended for a user by filtering the first item information with second preference information which represents an item preference of the client.

10. The server device of claim 9, wherein the first item information includes preference scores of items generated based on at least one of the number of accesses to the items by the clients of the neighborhood group and evaluation scores allocated to the items.

11. The server device of claim 10, wherein the preference generation unit determines whether the number of past accesses by the client to the items is equal to or greater than a predetermined number; requests the client to provide additional information for generating the first preference information when the number of the past accesses is less than the predetermined number; and generates the first preference information based on the additional information received in response to the request.

12. The server device of claim 10, wherein the preference generation unit determines whether the number of past accesses to the items of the server by the client is equal to or greater than a predetermined number, and generates the first preference information based on the number of accesses to the items of the server or the evaluation scores allocated to the items of the server when it is determined that the number of the past accesses is equal to or greater than the predetermined number.

13. The server device of claim 9, wherein the items relate to at least one of books, music, movies, and documents.

14. A client device for receiving a recommendation of information, the client device comprising:
a request transmission unit requesting a server to recommend information on at least one item among items of the server;
an information receiving unit receiving first item information on items preferred by clients of a neighborhood group, the neighborhood group selected based on first preference information which represents an item preference of the client;
a preference generation unit generating second preference information which represents an item preference of the client; and
an information generation unit generating second item information on items to be recommended for a user by filtering the received first item information with the second preference information,
wherein the neighborhood group is a group of clients having preferences similar to a preference corresponding to the first preference information.

15. The client device of claim 14, wherein the second preference information is information on a preference of categories of items included in the first item information that is generated based on a client's past result of accessing the items of the server.

16. The client device of claim 15, wherein the information generation unit generates second item information to be recommended for the user by calculating weighted values of preference scores of items included in the first item information and weighted values of preference scores corresponding to preferences of categories.

17. A method of recommending information, the method comprising:
generating first recommendation information by allowing a server to filter information with a first information filtering algorithm;
generating second recommendation information by allowing a client to filter the first recommendation information with a second information filtering algorithm; and
displaying the second recommendation information to a user.

18. The method of claim 17, wherein the first information filtering algorithm is a CC (collaborative filtering) algorithm, and wherein the second information filtering algorithm is an AA (attribute-aware) algorithm.

19. A computer program product for recommending information, the computer program product embodied on a computer readable medium and when executed by a computer system, performs the method comprising:
receiving a request from a client for recommending information on at least one item among items of the server;
generating first preference information by analyzing an item preference of the client;
selecting a neighborhood group including clients having preferences similar to a preference of the client; and
transmitting first item information to the client on at least one item preferred by the clients of the neighborhood group,
wherein the client receives the first item information and extracts second item information to be recommended to a user by filtering the first item information with second preference information which represents an item preference of the client.

20. A computer program product for receiving a recommendation of information, the computer program product embodied on a computer readable medium and when executed by a computer system, performs the method comprising:
requesting a server to recommend information on at least one item among items of the server;
receiving first item information at a client on items preferred by clients of a neighborhood group, the neighborhood group selected based on first preference information which represents an item preference of the client from the server; and
generating second item information on items to be recommended to a user by filtering the received first item information with second preference information which represents an item preference of the client,
wherein the neighborhood group is a group of clients having preferences similar to a preference corresponding to the first preference information.

21. A computer program product for recommending information, the computer program product embodied on a computer readable medium and when executed by a computer system, performs the method comprising:
generating first recommendation information by allowing a server to filter information with a first information filtering algorithm;
generating second recommendation information by allowing a client to filter the first recommendation information with a second information filtering algorithm; and
displaying the second recommendation information to a user.
